(19) United States
(12) Patent Application Publication
(10) Pub. No.: US 2020/0290006 A1
(43) Pub. Date: Sep. 17, 2020

(54) METHOD FOR PREPARING CAPSULES SENSITIVE TO PH OR UV RADIATION AND CAPSULES OBTAINED THEREFROM

(71) Applicant: CALYXIA, BONNEUIL-SUR-MARNE (FR)

(72) Inventors: Damien DEMOULIN, PARIS (FR); Jamie WALTERS, PARIS (FR); Karima OUHENIA, NEUILLY PLAISANCE (FR)

(73) Assignee: CALYXIA, BONNEUIL-SUR-MARNE (FR)

(21) Appl. No.: 16/756,523

(22) PCT Filed: Oct. 16, 2018
(86) PCT No.: PCT/EP2018/078269

§ 371 Date: Apr. 16, 2020

(30) Foreign Application Priority Data
Oct. 16, 2017 (FR) FR 17 59696

(51) Int. Cl. B01J 13/18; C08F 2/48

(52) U.S. Cl. CPC B01J 13/18; C08F 2/48

(57) ABSTRACT

The present invention relates to a method for preparing solid microcapsules, comprising the following steps, the addition, with stirring, of a composition C1, comprising at least one active ingredient, in a polymeric composition C2, the compositions C1 and C2 not being miscible with each other, wherein an emulsion (E1) is obtained comprising drops of composition C1 dispersed in composition C2. The addition, with stirring, of the emulsion (E1) in a composition C3, the compositions C2 and C3 not being miscible with each other, wherein a double emulsion (E2) is obtained comprising drops dispersed in composition C3. Applying shear to the emulsion (E2), wherein a double emulsion (E3) is obtained comprising drops of controlled size dispersed in composition C3; and polymerization of composition C2, wherein solid microcapsules are obtained dispersed in composition C3.

### CROSS REFERENCE TO RELATED APPLICATIONS

This is a U.S. National Phase Application under 35 U.S.C. § 371 of International Patent Application No. PCT/EP2018/078269, filed Oct. 16, 2018, which claims priority of French Patent Application No. 17 59696, filed Oct. 16, 2017. The entire contents of which are hereby incorporated by reference.

### FIELD OF THE INVENTION

The object of the present invention is a method for the preparation of capsules sensitive to pH or to UV. It also relates to the capsules obtained as well as compositions containing them.

### BACKGROUND

Many compounds, called active ingredients, are added to the formulated products in order to give them advantageous application properties, or to reinforce their performance.

However, in many cases, these substances may interfere negatively with other components present in the formulated product, and which may have harmful consequences on stability as well as leading to a decrease in performance.

### SUMMARY

The encapsulation of the active ingredients represents a very interesting means to overcoming the limitation of performance or stability of the formulated products containing them, while benefiting from the effect of the active ingredient at the time of the use of the formulated product.

The performance of a microencapsulated ingredient is assessed on the basis of 3 criteria: the retention of the active ingredient, i.e. the ability of the capsule not to allow the active ingredient to leak into the external environment; the protection of the active ingredient, i.e. the ability of the capsule to block the penetration of contaminating species from the external environment; and the release, i.e. the ability of the capsule to let the active ingredient disperse into the external environment at the time and place where its action is desired.

Many capsules have been developed to isolate active ingredients in formulated products. These capsules are the result of manufacturing methods such as spray-drying, interfacial polymerization, interfacial precipitation, or solvent evaporation among many others.

Furthermore, many chemical methods are known to those skilled in the art for creating pH-sensitive materials, i.e. those whose solubility in water may change under the influence of a change in pH. This change in solubility may, for example, be induced by the ionization of the material, by the formation or destruction of hydrogen bonds in the material, or by a change in conformation of the material. Many chemical methods are also known to those skilled in the art for creating UV-sensitive materials, i.e. materials whose solubility in water may change when they are subjected to light radiation and, in particular, UV radiation.

This change in solubility may be induced, for example, by isomerization of the material under the influence of UV radiation.

Combining knowledge of the capsule formation methods and the methods of manufacturing pH-sensitive materials, application CN105646890 thus describes nanocapsules formed by nucleation-polymerization of a pH-sensitive polymer, of a hydrophilic polymer, of a crosslinking agent, and an encapsulant in the presence of a catalyst. This results in matrix particles in the pores of which the active ingredient is found. It should be noted that the very long crosslinking time and the complexity of the method limit its industrial use, while the lack of control of the structures obtained promotes the escape of the encapsulated active ingredients.

Similarly, application JPH0330831 describes microcapsules formed by the precipitation of pectin around droplets of an active ingredient. Application JP2006255536 describes the preparation of a pH-sensitive copolymer in order to form matrix particles by solvent evaporation. The active ingredient is found in the pores of these particles. The products described in these two documents have the ability to dissolve upon a change in pH so as to release their content. However, the lack of crosslinking of the capsule shell material results in insufficient retention and protection performance in most areas of formulation chemistry.

Combining the knowledge on the methods of forming capsules and the methods of manufacturing materials sensitive to UV radiation, application US2016235685 describes capsules manufactured by the layer-by-layer deposition of polyelectrolytes of opposite charges on a material forming the core of the capsules (method known under the name of “LbL deposition”). The entire outer layer of the capsules is made of UV-sensitive material. Thus, when the capsules are subjected to UV radiation, a significant leak of the active ingredient contained in the core of the capsules is triggered. Again, the high porosity due to the lack of crosslinking of the capsule shell, results in unsatisfactory retention and protection performance in most areas of formulation chemistry.

Similarly, application CN101408722 describes capsules sensitive to UV radiation produced by interfacial polymerization of a polyol containing a photosensitive group and a diisocyanate. The resulting capsules feature high porosity, which again results in retention and protective properties that are unsatisfactory in most fields of formulation chemistry.

There is a need in several fields of formulation chemistry to release an active ingredient upon a change in pH of the external environment or during light irradiation and, in particular, UV irradiation. Developing capsules with good pH or UV sensitivity without compromising their retention and protection performance is a challenge to which encapsulation solutions known to those skilled in the art has so far been unable to respond satisfactorily.

The present invention, therefore, aims to provide a method for encapsulating active ingredients with high retention and protective properties, while allowing the release of said active ingredient when the capsules are subjected to a change in pH of the external environment, or UV radiation.

The present invention aims to provide capsules whose shell is formed by a crosslinked material having excellent retention and protective properties, while having the ability to release their content when the capsules are subjected to a change in pH of the external environment or UV radiation.

Thus, the present invention relates to a method for preparing solid microcapsules, said solid microcapsules comprising, in particular, a core containing at least one active ingredient and a solid shell completely encapsulating said core at its periphery, said solid shell comprising pores with a size less than 1 nm,
said method comprising the following steps:
a) the addition, with stirring, of a composition C1, comprising at least one active ingredient, to a polymeric composition C2, the compositions C1 and C2 not being miscible with each other,
composition C2 comprising:
   at least one crosslinkable monomer or polymer M1 with an average molecular weight of less than 5,000 g·mol⁻¹,
   at least one monomer or polymer M2 having a chemical group sensitive to pH or to UV,
   at least one crosslinking agent with an average molecular weight of less than 5,000 g·mol⁻¹,
   and, optionally, at least one photoinitiator with an average molecular weight of less than 5,000 g·mol⁻¹, or a crosslinking catalyst with an average molecular weight of less than 5,000 g·mol⁻¹,
   the viscosity of the composition C2 being between 500 mPa·s and 100,000 mPa·s at 25° C., and preferably being greater than the viscosity of the composition C1,
   wherein an emulsion (E1) is obtained comprising drops of composition C1 dispersed in composition C2;
b) the addition, with stirring, of the emulsion (E1) to a composition C3, the compositions C2 and C3 not being miscible with each other, the viscosity of composition C3 being between 500 mPa·s and 100,000 mPa·s at 25° C., and preferably being greater than the viscosity of the emulsion (E1), wherein a double emulsion (E2) is obtained comprising drops dispersed in composition C3;
c) the application of shear to the emulsion (E2), wherein a double emulsion (E3) is obtained comprising drops of controlled size dispersed in the composition C3; and
d) polymerization of composition C2, wherein solid microcapsules are obtained dispersed in the composition C3.

The method of the invention therefore makes it possible to prepare solid microcapsules comprising a core and a solid shell totally encapsulating the core at its periphery, wherein the core is a composition C1 comprising at least one active ingredient.

Preferably, the solid microcapsules obtained by the method of the invention are formed of a core containing at least one active ingredient (composition C1), and a solid shell (obtained from composition C2) completely encapsulating said core at its periphery, said solid shell comprising pores with a size less than 1 nm.

According to the invention, the crosslinkable monomer or polymer M1 and the monomer or polymer M2 as defined above, are different entities. Thus, M1 and M2 are different.

According to one embodiment, the monomers or polymers M1 and M2, the crosslinking agent, and the photoinitiator as defined above, are separate entities.

According to the invention, the shell of the microcapsules so obtained is formed by a hybrid or composite material, obtained from the abovementioned monomers or polymers M1 and M2, and described in more detail below.

When M2 comprises at least one chemical group sensitive to pH, unlike the capsules of the prior art, the shell of the capsules of the invention does not completely dissolve when the pH of the external environment changes, but becomes only porous. In fact, in the presence of a change in pH of the external environment, the change in solubility of the monomers or polymers M2 creates pores in the shell of the capsules, thus triggering the release of the active ingredient. The size of the pores created may be controlled by modulating the proportion of monomers or polymers M2 in the shell material and their miscibility with the monomers or polymers M1.

The capsules of this variant of the invention thus have the ability to be non-porous at a certain pH and porous after a change in pH, and combine very good protective, retention and pH-sensitive properties.

When M2 comprises at least one chemical group sensitive to UV radiation, unlike the capsules of the prior art, the shell of the capsules of the invention is entirely non-porous in the absence of UV radiation, while becoming porous under UV irradiation. In fact, in the presence of UV radiation, the change in solubility due to the reactivity or isomerization of the monomers or polymers M2, creates pores in the shell of the capsules, thereby triggering the release of the active ingredient. The size of the pores created may be controlled by modulating the proportion of monomers or polymers M2 in the shell material, and their miscibility with the monomers or polymers M1.

The capsules of this variant of the invention thus have the ability to be non-porous in the absence of UV radiation and porous when subjected to UV radiation, combining both very good protection and retention properties and sensitivity to UV radiation.

The capsules obtained by this method have excellent protection and retention capacities

This level of performance is achieved thanks to the shell material of the capsules, the pore size of which is preferably less than 1 nm, so that the diffusion of any compound with a molecular size greater than 1 nm is very greatly slowed down when it is not completely stopped.

This result is obtained by controlling one or more parameters as described below, such as the ratio of core/shell material of the capsules (ratio C1/C2 below), the concentration of a crosslinking agent in the material, the number of reactive ends per monomer or polymer/oligomer, the length of the monomers or polymers/oligomers, and/or the absence of inert materials in the shell material, such as solvents or non-reactive oligomers or polymers.

The method of the invention also has the advantage of not requiring the use of surfactants or emulsifiers that could accelerate and cause the release of the active ingredients outside the capsule to be uncontrolled; and/or react with the components of the formulated product in which the capsules are intended to be incorporated.

The method of the invention consists in producing a double emulsion composed of droplets containing at least one active ingredient, enveloped in a crosslinkable liquid phase. These double drops are then made monodisperse in size before being transformed by crosslinking or polymerization into rigid capsules. Preparation involves 4 steps described below in detail.

### Step a)

Step a) of the method according to the invention consists in preparing a first emulsion (E1).

The first emulsion consists of a dispersion of droplets of the composition C1 (containing at least one active ingredient) in a polymeric composition C2 immiscible with C1, created by dropwise addition of C1 to C2 with stirring.

During step a), a composition C1 is added to a crosslinkable polymeric composition C2, this step being carried out with stirring, which means that the composition C2 is stirred, typically mechanically, while the composition C1 is added so as to emulsify the mixture of compositions C1 and C2.

The addition of composition C1 to composition C2 is typically carried out dropwise.

During step a), the composition C1 is at a temperature between 0° C. and 100° C., preferably between 10° C. and 80° C., and more preferably between 15° C. and 60° C. During step a), composition C2 is at a temperature between 0° C. and 100° C., preferably between 10° C. and 80° C., and more preferably between 15° C. and 60° C. Under the addition conditions of step a), the compositions C1 and C2 are not miscible with each other, which means that the quantity (by weight) of the composition C1 capable of being dissolved in composition C2 is less than or equal to 5%, preferably less than 1%, and more preferably less than 0.5%, relative to the total weight of the composition C2, and that the quantity (by weight) of composition C2 capable of being dissolved in composition C1 is less than or equal to 5%, preferably less than 1%, and more preferably less than 0.5%, relative to the total weight of composition C1.

Thus, when the composition C1 comes into contact with the composition C2 with stirring, the latter is dispersed in the form of drops, called simple drops.

The immiscibility between the compositions C1 and C2 also makes it possible to avoid the migration of the active ingredient from composition C1 to composition C2.

The composition C2 is stirred so as to form, during the addition of the composition C1, an emulsion comprising drops of composition C1 dispersed in the composition C2. This emulsion is also called “simple emulsion” or C1-in-C2 emulsion.

To implement step a), one may use any type of agitator typically used to form emulsions, such as, for example, a mechanical paddle stirrer, a static foam concentrate, an ultrasonic homogenizer, a membrane homogenizer, a high-pressure homogenizer, a colloid mill, a high-shear disperser, or a high-speed homogenizer.

### Composition C1

Composition C1 comprises at least one active ingredient A. This composition C1 serves as a vehicle for active ingredient A in the method of the invention, in the drops formed during the method of the invention, and in the solid capsules so obtained.

According to a first variant of the method of the invention, the composition C1 is monophasic, i.e. it is a pure active ingredient A, or else a solution comprising the active ingredient A in dissolved form.

According to one embodiment, the active ingredient is dissolved in composition C1.

According to this variant, composition C1 typically consists of a solution of the active ingredient A in an aqueous solution, or an organic solvent, or a mixture of organic solvents, wherein the active ingredient A is present in a weight content of from 1% to 99%, relative to the total weight of composition C1. Active ingredient A may be present according to a weight content ranging from 5% to 95%, from 10% to 90%, from 20% to 80%, from 30% to 70%, or from 40% to 60%, relative to the total weight of composition C1.

According to another embodiment, composition C1 consists of the active ingredient A.

According to another embodiment of the invention, composition C1 is a biphasic composition, which means that the active ingredient is dispersed, either in liquid form or in solid form, in composition C1, and is not completely dissolved in said composition C1.

According to another embodiment, the active ingredient is dispersed in the form of solid particles in composition C1.

According to this embodiment, composition C1 may consist of a dispersion of solid particles of the active ingredient in an organic solvent or in a mixture of organic solvents.

According to this embodiment, composition C1 may consist of a dispersion of solid particles of the active ingredient in an aqueous phase, which comprises water and optionally hydrophilic organic solvents.

The active ingredient used may be, for example:
a crosslinking agent, a hardener, an organic or metallic catalyst (such as an organometallic or inorganometallic complex of platinum, palladium, titanium, molybdenum, copper, zinc) used to polymerize polymer, elastomer formulations, rubber, paint, adhesive, sealant, mortar, varnish or coating;
a dye or pigment intended for formulations of elastomers, paint, coating, adhesive, joint, mortar, or paper;
a fragrance (within the meaning of the molecule list established by the International Fragrance Association (IFRA) and available on the website www.ifraorg.org) intended for detergency such as detergents, home care products, cosmetic and personal care products, textiles, paints, coatings;
an aroma, a vitamin, an amino acid, a protein, a lipid, a probiotic, an antioxidant, a pH corrector, a preservative for food compounds and animal feed;
a softener, a conditioner for detergency products, detergents, cosmetics and personal care products. As such, the active ingredients that may be used are, for example, listed in U.S. Pat. Nos. 6,335,315 and 5,877,145;
an anti-color alteration agent (such as an ammonium derivative), an anti-foaming agent (such as an alcohol ethoxylate, an alkylbenzene sulfonate, a polyethylene ethoxylate, an alkylethoxysulfate or alkylsulfate) intended for detergency products, detergents, and home care products;
a brightening agent, also called color activator (such as a stilbene derivative, a coumarin derivative, a pyrazoline derivative, a benzoxazole derivative or a naphthalimide derivative) intended for detergency products, detergents, cosmetics, and personal care products;
a biologically-active compound such as an enzyme, a vitamin, a protein, a plant extract, an emollient agent, a disinfecting agent, an antibacterial agent, an anti-UV agent, a pharmacologically-active synthetic molecule intended for cosmetic products and personal care, pharmaceuticals and so-called “smart” textiles. Among these biologically-active compounds, mention may be made of: vitamins A, B, C, D and E, para-aminobenzoic acid, alpha hydroxyl acids (such as glycolic acid, lactic acid, malic acid, tartaric or citric acid), camphor, ceramides, polyphenols (such as flavonoids, phenolic acid, ellagic acid, tocopherol, ubiquinol), hydroquinone, hyaluronic acid, isopropyl isostearate, isopropyl palmitate, oxybenzone, panthenol, proline, retinol, retinyl palmitate, salicylic acid, sorbic acid, sorbitol, triclosan, tyrosine;
a disinfecting agent, an antibacterial agent, an anti-UV agent, intended for paints and coatings;
a fertilizer, a herbicide, an insecticide, a pesticide, a fungicide, a repellant or a disinfectant intended for agrochemicals;
a flame retardant, (such as a brominated polyol such as tetrabromobisphenol A, a halogenated or non-halogenated organophosphorus compound, a chlorinated compound, an aluminum trihydrate, an antimony oxide, a zinc borate, red phosphorus, melamine, or magnesium dihydroxide) for plastics, coatings, paints and textiles;
a photonic crystal or a photochromophore intended for paints, coatings and polymeric materials forming curved and flexible screens;
a product known to those skilled in the art as phase change materials (PCM for Phase Change Materials) capable of absorbing or returning heat when they undergo a phase change, intended for the storage of energy.

Examples of PCMs and their applications are described in “A review on phase change energy storage: materials and applications”, Farid et al., Energy Conversion and Management, 2004, 45 (9-10), 1597-1615. As examples of PCM, may be mentioned molten salts of aluminum phosphate, ammonium carbonate, ammonium chloride, cesium carbonate, cesium sulfate, calcium citrate, calcium chloride, hydroxide calcium, calcium oxide, calcium phosphate, calcium saccharate, calcium sulfate, cerium phosphate, iron phosphate, lithium carbonate, lithium sulfate, magnesium chloride, magnesium sulfate, manganese chloride, manganese nitrate, manganese sulfate, potassium acetate, potassium carbonate, potassium chloride, potassium phosphate, rubidium carbonate, rubidium sulfate, disodium tetraborate, sodium acetate, sodium bicarbonate, sodium bisulfate, sodium citrate, sodium chloride, sodium hydroxide, sodium nitrate, sodium percarbonate, sodium persulfate, sodium phosphate, sodium propionate, sodium selenite, sodium silicate, sodium sulfate, sodium tellurate, sodium thiosulfate, strontium hydrophosphate, zinc acetate, zinc chloride, sodium thiosulfate, paraffinic hydrocarbon s waxes, polyethylene glycols.

### Composition C2

Composition C2 is intended to form the future solid shell of the microcapsules. Preferably, the viscosity of composition C2 at 25° C. is between 1,000 mPa·s and 50,000 mPa·s, preferably between 2,000 mPa·s and 25,000 mPa·s, and, for example, between 3,000 mPa·s and 15,000 mPa·s.

Preferably, the viscosity of composition C2 is greater than the viscosity of composition C1.

The viscosity is measured using a Haake Rheostress™ 600 rheometer equipped with a cone with a diameter of 60 mm and a 2 degree angle, and with a temperature regulation cell set at 25° C. The viscosity value is read for a shear rate equal to 10 s^{-1.}

Preferably, the interfacial tension between the compositions C1 and C2 is low. Typically, these interfacial tensions vary between 0 mN/m and 50 mN/m, preferably between 0 mN/m and 20 mN/m.

The low interfacial tension between the compositions C1 and C2 also advantageously makes it possible to ensure the stability of the emulsion (E1) obtained at the end of step a).

Composition C2 comprises:
at least one crosslinkable monomer or polymer M1 with an average molecular weight of less than 5,000 g·mol⁻¹, at least one monomer or polymer M2 having a chemical group sensitive to pH or to UV, M2 being, in particular, different from M1,
at least one crosslinking agent with an average molecular weight of less than 5,000 g·mol⁻¹,
and, optionally, at least one photoinitiator with an average molecular weight of less than 5,000 g·mol⁻¹ or a crosslinking catalyst with an average molecular weight of less than 5,000 g·mol⁻¹, thus making it crosslinkable.

The importance of the choice of monomers, polymers and crosslinking agents is crucial, since these components will dictate the properties of retention and sensitivity to pH or UV radiation of the future rigid shell of the capsules. In particular, this choice is important in that it makes it possible to obtain capsules whose rigid shell contains pores with a size less than 1 nm.

The rigid shell of the capsules, therefore, is formed of a polymeric material resulting from the crosslinking of composition C2. The dense molecular network thus formed, however, has interstices (or voids) creating a hypothetical passage between the interior and exterior of the capsules. These interstices constitute the pores of the rigid shell. According to the invention, the pores have a size preferably less than 5 nm, more preferably less than 1 nm, or even less than 0.5 nm.

In the context of the present invention, the term “size” denotes the diameter, in particular, the average diameter, of the pores.

The size of the pores may be measured, for example, by surface analysis according to the so-called BET technique (Brunauer-Emmet-Teller) that is well known to those skilled in the art. This technique, described in more detail in “The Journal of the American Chemical Society” of February 1938, volume 60, page 309, consists in measuring the nitrogen absorption by the sample whose pore size is to be measured. The pressure of the reference cell in which the adsorbate is at its saturated vapor pressure, and that of the cell of the sample into which known volumes of adsorbate are to be injected, are then measured. The curve resulting from these measurements is the adsorption isotherm. A mathematical model is used to deduce the specific surface area of the capsules, and consequently the size of the pores.

According to the invention, the term “monomer” or “polymer” designates any base unit suitable for the formation of a solid material by polymerization, either alone or in combination with other monomers or polymers. The term “polymer” also includes oligomers.

According to the invention, the monomers or polymers M1 are crosslinkable monomers or polymers ensuring excellent retention and protection properties.

Preferably, the monomers or polymers M1 are chosen from monomers or polymers comprising at least one reactive function chosen from among the group constituting the functions of acrylate, methacrylate, vinyl ether, N-vinyl ether, mercaptoester, thiolene, siloxane, epoxy, oxetane, urethane, isocyanate and peroxide.

In particular, the monomers or polymers M1 may be chosen from the monomers or polymers carrying at least one of the reactive functions mentioned above, and further carrying at least one function chosen from among the group constituting the functions of primary, secondary and tertiary alkylamine functions, quaternary amine functions, and functions of sulfate, sulfonate, phophate, phosphonate, carboxylate, hydroxyl, halogen, and mixtures thereof.

The polymers M1 may be chosen from among polyethers, polyesters, polyurethanes, polyureas, polyethylene glycols, polypropylene glycols, polyamides, polyacetals, polyimides, polyolefins, polysulphides and polydimethylsiloxanes, said polymers additionally carrying at least one reactive function chosen from among the group constituting the functions of acrylate, methacrylate, vinyl ether, N-vinyl ether, mercaptoester, thiolene, siloxane, epoxy, oxetane, urethane, isocyanate and peroxide.

Among the examples of such polymers, may be mentioned but not exclusively, the following polymers: poly(2-(1-naphthyloxy)-ethyl acrylate), poly(2(2-naphthyloxy)-ethyl acrylate), poly(2-(2-naphthyloxy)-ethyl methacrylate), polysorbitol dimethacrylate, polyacrylamide, poly((2-(1-naphthyloxy)ethanol), poly(2-(2-naphthyloxy)ethanol), poly(1-chloro-2,3-epoxypropane), poly(n-butyl isocyanate), poly(N-vinyl carbazole), poly(N-vinyl pyrrolidone), poly(p-benzamide), poly(p-chlorostyrene), poly(p-methyl styrene), poly(p-phenylene oxide), poly(p-phenylene sulfide), poly(N-(methacryloxyethyl)succinimide), polybenzimidazol, polybutadiene, polybutylene terephthalate, polychloral, polychloro trifluoro ethylene, polyether imide, polyether ketone, polyether sulfone polyhydridosilsesquioxane, poly(m-phenylene isophthalamide), poly(methyl 2-acrylamido-2-methoxyaceate), poly(2-acrylamido-2-methylpropanesulfonic acid), poly-mono-butyl maleate, polybutyl methacrylate, poly(N-tert-butylmethacrylamide), poly(Nn-butylmethacrylamide), polycyclohexylmethacrylamide, poly(m-xylenebisacrylamide2,3-dimethyl-1,3-butadiene, N, N-dimethylmethacrylamide), poly(n-butyl methacrylamide)), poly(cyclohexyl methacrylate), polyisobutyl methacrylate, poly(4-cyclohexylstyrene), polycyclol acrylate, polycyclol methacrylate, polydiethyl ethoxymethylenemalonate, poly(2,2,2-trifluoroethyl methacrylate), poly(1,1,1,-trimethylolpropyl, polymethacrylate, poly(N,N-dimethylaniline, dihydrazide), poly(isophthalic dihydrazine), isophthalic polyacid, polydimethyl benzilketal, epichlorohydrin, poly(3,3-ethyl-diethoxyacrylate), poly(3,3-dimethylacrylate), poly(ethyl vinyl ketone), poly(vinyl ethyl ketone), poly(penten-3-one), polyformaldehyde poly(diallyl acetal), polyfumaronitrile, polyglyceryl propoxy triacrylate, polyglyceryl trimethacrylate, polyglycidoxypropyltrimethoxysilane, polyglycidyl acrylate, poly(n-heptyl acrylate), poly(n-heptyl ester of acrylic acid), poly(n-heptyl methacrylate), poly(3-hydroxypropionitrile), poly(2-hydroxypropyl acrylate), poly(2-hydroxypropyl methacrylate), poly(N-(methacryloxyethyl) phthalimide), poly(1,9-nonanediol diacrylate), poly(1,9-nonanediol dimethacrylate), poly(N-(n-propyl) acrylamide), poly(ortho-phthalic acid), poly(isophthalic acid), poly(l,4-benzenedicarboxylic acid), poly(1,3-benzenedicarboxylic acid), poly(phthalic acid), poly(mono-2-acryloxyethyl ester), polyterephthalic acid, phthalic polyanhydride, polyethylene glycol diacrylate, polyethylene glycol methacrylate, polyethylene glycol dimethacrylate, poly(isopropyl acrylate), polysorbitol pentaacrylate, polyvinyl bromoacetate, polychloroprene, poly(di-n-hexyl silylene), poly(di-n-propyl siloxane), polydiphenyl siloxane, polyvinyl propionate, polyvinyl triacetoxysilane, polyvinyl tris-tert-butoxysilane, polyvinyl butyral, polyvinyl alcohol, polyvinyl acetate, polyethylene co-vinyl acetate, poly(bisphenol-A polysulfone), poly(1,3-dioxepane), poly(1,3-dioxolane), poly(1,4-phenylene vinylene), poly(2,6-dimethyl-1A-phenylene oxide), poly(4-hydroxybenzoic acid), poly(4-methyl pentene-1), poly(4-vinyl pyridine), polymethylacrylonitrile, polymethylphenylsiloxane, polymethylsilmethylene, polymethylsilsesquioxane, poly(phenylsilsesquioxane), poly(pyromellitimide-1.4-diphenyl ether), polytetrahydrofuran, polythiophene, poly(trimethylene oxide), polyacrylonitrile, polyether sulfone, polyethylene-co-vinyl acetate, poly(perfluorethylene propylene), poly(perfluoralkoxylalkane) styrene-acrylonitrile).

According to the invention, the monomers or polymers M2 are monomers or polymers, distinct from M1, having a chemical group sensitive to pH or to UV radiation, being crosslinkable or non-crosslinkable, and miscible or immiscible, with the monomers or polymers M1.

According to one embodiment, M2 is chosen from monomers or polymers having a chemical group sensitive to pH.

Preferably, the pH-sensitive monomers or polymers M2 are chosen from monomers or polymers comprising at least one function chosen from the group constituting the acceptors or proton donors in response to a change in pH such as the groups of pyridine, pyrrolydine, imidazole, piperazine, morpholino, primary amine, secondary amine, tertiary amine, carboxyl, sulfonic, phosphate. In addition, the monomers or polymers M2 may be chosen from monomers or polymers comprising at least one chemical bond which may be destroyed under the action of a pH change, such as an orthoester, lactone or ester function.

By way of example of such compounds may be mentioned but not exclusively, the following polymers: poly(L-glutamic acid) (PLGA), poly(histidine) (PHIS), poly(aspartic acid), poly(2-acrylamido-2-methylpropane sulfonic acid), poly(4-styrenesulfonic acid), poly(2-dimethylaminoethyl methacrylate), poly(2-diethylaminoethyl methacrylate), poly(2-diisopropylaminoethyl methacrylate), poly(4-vinylpyridine) (P4VP), poly(2-vinyl-pyridine) (P2VP), poly(ethyleneimine) (PEI), poly(propylene imine) (PPI), poly(amido-amine), polystyrene-β-poly(acrylic acid), poly(c-caprolactone)-b-poly(acrylic acid), poly(aspartic acid), poly(2-vinylpyridine), chitosan, gelatin, the family of methyl methacrylate-methacrylic acid, polyvinyl acetate phthalate, hydroxyl propyl methyl cellulose phthalate (HPMC), cellulose acetate trimellate, cellulose acetate phthalate copolymers, in particular commercialized by the company Evonik under the trade names Eudragit L 100, L-30 D, S 100, FR 30 D, L 100-55, E100, E PO, E12.5, as well as all of the compounds described in Kocak et al., Polymer Chemistry, 2017, 8,144.

According to one variant of this embodiment, the monomers and polymers described above also comprise at least one reactive function chosen from among the group constituting the functions of acrylate, methacrylate, vinyl ether, N-vinyl ether, mercaptoester, thiolene, siloxane functions, epoxy, oxetane, urethane, isocyanate and peroxide.

According to another embodiment, M2 is chosen from monomers or polymers having a chemical group sensitive to UV.

Preferably, the monomers or polymers M2 are chosen from monomers or polymers comprising at least one function chosen from among the group constituting the functions of azobenzene, stilbene, spiropyran, 2-diazo-1,2-naphthoquinone, o-nitrobenzylester, triphenylmethane, coumarin functions, thiol, or 6-nitro-veratroyloxycarbonyle, such as the compounds described in particular in Liu et al., Polymer Chemistry 2013, 4, 3431-3443, Tomatsu et al., Adv. Drug Deliv. Rev., 2011, 63, 1257, or even Marturano et al., Polymers, 2017, 9(1), 8.

According to a preferred embodiment, the monomer or polymer M2 is chosen from the group constituting:
monomers or polymers comprising at least one function chosen from among the group constituting the functions of pyridine, pyrrolydine, imidazole, piperazine, morpholino, primary amine, secondary amine, tertiary amine, carboxyl, sulfonic and phosphate;
monomers or polymers comprising at least one chemical bond chosen from the orthoester, lactone or ester functions; and
monomers or polymers comprising at least one function chosen from among the group constituting the functions of azobenzene, stilbene, spiropyran, 2-diazo-1,2-naphthoquinone, o-nitrobenzylester, triphenylmethane, coumarin, thiol and 6-nitro-veratroyloxycarbonyl. According to one variant of this embodiment, the monomers and polymers described above further comprise at least one reactive function chosen from among the group constituting the functions of acrylate, methacrylate, vinyl ether, N-vinyl ether, mercaptoester, thiolene, siloxane functions, epoxy, oxetane, urethane, isocyanate and peroxide.

By “crosslinking agent” is meant a compound carrying at least two reactive functions capable of crosslinking a monomer or a polymer, or a mixture of monomers or polymers, during its polymerization.

The crosslinking agent may be chosen from molecules carrying at least two functions chosen from among the group constituting the functions of acrylate, methacrylate, vinyl ether, N-vinyl ether, mercaptoester, thiolene, siloxane, epoxy, oxetane, urethane, isocyanate and peroxide.

According to one embodiment, the crosslinking agent is different from the monomers or polymers M1 and M2 as defined above.

As a crosslinking agent, may be mentioned in particular:
diacrylates, such as 1,6-hexanediol diacrylate, 1,6-hexanediol dimethacrylate, polyethylene glycol dimethacrylate, 1,9-nonanediol dimethacrylate, 1,4-butanediol dimethacrylate, 2,2-bis(4-methacryloxyphenyl) propane, 1,3-butanediol dimethacrylate, 1,10-decanediol dimethacrylate, bis(2-methacryloxyethyl)N,N′-1,9-nonylene biscarbamate, 1,4-butanediol diacrylate, ethylene glycol diacrylate, 1,5-pentanediol dimethacrylate, 1,4-Phenylene diacrylate, allyl methacrylate, N,N′-methylenebisacrylamide, 2,2-bis[4-(2-hydroxy-3-methacryloxypropoxy) phenyl] propane, tetraethylene glycol diacrylate, ethylene glycol dimethacrylate, diethylene glycol diacrylate, triethylene glycol diacrylate, triethylene glycol dimethacrylate, polyethylene glycol diglycidyl ether, N,N-diallylacrylamide, 2,2-bis[(2-acryloxyethoxy)phenyl] propane, glycidyl methacrylate;
multifunctional acrylates such as dipentaerythritol pentaacrylate, 1,1,1-trimethylolpropane triacrylate, 1,1,1-trimethylolpropane trimethacrylate, ethylenediamine tetramethacrylate, pentaerythritol triacrylate, pentaerythritol tetraacrylate;
acrylates also having another reactive function, such as propargyl methacrylate, 2-Cyanoethyl acrylate, tricyclodecane dimethanol diacrylate, hydroxypropyl methacrylate, N-acryloxysuccinimide, N-(2-hydroxypropyl) methacrylamide, N-(3-aminopropyl) methacrylamide hydrochloride, N-(t-BOC-aminopropyl) methacrylamide, 2-aminoethyl methacrylate hydrochloride, monoacryloxyethyl phosphate, o-nitrobenzyl methacrylate, acrylic anhydride, 2-(tert-butylamino) ethyl methacrylate, N,N-diallylacrylamide, glycidyl methacrylate, 2-hydroxyethyl acrylate, 4-(2-acryloxyaehoxy)-2-hydroxybenzophenone, N-(Phthalimidomethyl) acrylamide, cinnamyl methacrylate.

By “photoinitiator” is meant a compound capable of fragmenting under the effect of light radiation.

The photoinitiators that may be used according to the present invention are known in the prior art and are described, for example in “Les photoinitiateurs dans la reticulation des revêtements” G. Li Bassi, Double Liaison—Chimie des Peintures, No. 361, November 1985, p. 34-41; “Applications industrielles de la polymérisation photoinduite”, Henri Strub, L′Actualité Chimique, February 2000, p. 5-13; and “Photopolymèes: considerations théoriques et reaction de prise”, Marc, J. M. Abadie, Double Liaison—Chimie des Peintures, No. 435-436, 1992, p. 28-34.

According to one embodiment, the photoinitiator is different from the monomers or polymers M1 and M2 as defined above.

These photoinitiators include:
α-hydroxyketones, such as 2-hydroxy-2-methyl-1-phenyl-1-propanone, sold, for example, under the names DAROCUR® 1173 and 4265, IRGACURE® 184, 2959, and 500 by the company BASF, and ADDITOL® CPK by the company CYTEC; -α-aminoketones, in particular 2-benzyl-2-dimethylamino-1-(4-morpholinophenyl)-butanone-1, sold, for example, under the names IRGACURE® 907 and 369 by the company BASF;
the aromatic ketones sold, for example, under the name ESACURE® TZT by LAMBERTI; or the thioxanthones sold, for example, under the name ESACURE® ITX by LAMBERTI, and the quinones. These aromatic ketones most often require the presence of a hydrogen donor compound such as tertiary amines and, in particular, alkanolamines. Mention may be made, in particular, of the tertiary amine ESACURE® EDB sold by the company LAMBERTI.
the a-dicarbonyl derivatives, the most common representative of which is benzyldimethylketal sold under the name IRGACURE® 651 by BASF. Other commercial products are marketed by LAMBERTI under the name ESACURE® KB1, and
the acylphosphine oxides, such as, for example, the bis-acylphosphine oxides (BAPO) sold, for example, under the names IRGACURE® 819, 1700, and 1800, DAROCUR® 4265, LUCIRIN® TPO, and LUCIRIN® TPO-L by BASF.

Among the photoinitiators, mention may also be made of aromatic ketones such as benzophenone, phenylglyoxylates, such as the methyl ester of phenyl glyoxylic acid, oxime esters, such as [1-(4-phenylsulfanylbenzoyl) heptylideneamino] benzoate, sulfonium salts, iodonium salts and oxime sulfonates.

In particular, according to the invention, the ratio of the total weight of M2 contained in C2 to the total weight of M1 contained in C2 is between 0.001 and 0.5, preferably between 0.01 and 0.3, more preferably between 0.01 and 0.1.

According to the invention, the average molecular weight of the monomers or polymers M1 of composition C2 is less than 5,000 g·mol⁻¹. Preferably, this average molecular weight is between 50 g·mol^{-1 and} 3000 g·mol⁻¹, more preferably between 100 g·mol⁻¹ and 2000 g·mol^{-1.}

According to the invention, the average molecular weight of the crosslinking agent(s) of composition C2 is less than 5,000 g·mol⁻¹. Preferably, this average molecular weight is between 50 g·mol^{-1 and} 2000 g·mol⁻¹, more preferably between 50 g·mol⁻¹ and 1000 g·mol⁻¹.

According to the invention, the average molecular weight of the initiator or crosslinking catalyst of the composition C2 is less than 5,000 g·mol⁻¹. Preferably, this average molecular weight is between 50 g·mol⁻¹ and 3000 g·mol⁻¹, more preferably between 100 g·mol⁻¹ and 2000 g·mol⁻¹.

The use of such constituents makes it possible to obtain a shorter distance between the crosslinking points in the shell material of the capsules of the invention.

Thus, according to one embodiment, composition C2 only comprises molecules with an average molecular weight of less than 5,000 g·mol⁻¹. If composition C2 comprises a molecule other than the monomers or polymers, crosslinking agents or initiator or crosslinking catalyst mentioned above, this molecule will have an average molecular weight of less than 5000 g·mol⁻¹.

According to one embodiment, the volume fraction of C1 in C2 is between 0.1 and 0.5.

This choice of the volume fraction of C1 in C2 makes it possible to advantageously control the thickness of the shell of the capsules obtained at the end of the method to between 0.2 μm and 8 μm, as a function of the size of the capsules (themselves between 1 μm and 30 μm).

According to one embodiment, composition C2 comprises from 5% to 30% by weight of crosslinking agent(s) relative to the total weight of said composition. Preferably, composition C2 may comprise from 5% to 20%, and more preferably from 5% to 15%, by weight of crosslinking agent(s) relative to the total weight of said composition.

According to one embodiment, the ratio of the number of moles of reactive functions of the monomers or polymers (or oligomers) M1 contained in C2 relative to the number of moles of monomers or polymers (or oligomers) M1 contained in C2, is greater than 1.5, preferably between 1.7 and 3.

This embodiment is advantageous in that it makes it possible to have a greater number of crosslinking points in the shell material of the capsules.

According to the invention, the term “reactive function” designates an atom or a group of atoms present in the monomer or polymer and capable of creating a covalent chemical bond with another molecule included in C2. Among these functions, mention may be made, for example, of the functions of acrylate, methacrylate, vinyl ether, N-vinyl ether, mercaptoester, thiolene, siloxane, epoxy, oxetane, urethane, isocyanate and peroxide.

According to the invention, the term “molecules contained in C2” denotes all the molecules contained in the composition C2 mentioned above, and therefore, in particular, the monomers or polymers, crosslinking agents and initiators or catalysts mentioned above.

According to one embodiment, the composition C2 does not comprise molecules other than the monomers or polymers, crosslinking agents and initiators or catalysts mentioned above. Thus, preferably, the molecules contained in composition C2 consist of the monomers or polymers, crosslinking agents and initiators or catalysts mentioned above.

According to one embodiment, the composition C2 comprises a monomer (or polymer) M1, a monomer (or polymer) M2, a crosslinking agent and a (photo) initiator.

In the context of the present invention, the “number of moles of reactive functions of the monomers or polymers M1 contained in C2 relative to the number of moles of monomers or polymers M1 contained in C2” may be determined by counting the number of moles of reactive functions of the monomers or polymers M1 contained in C2 divided by the number of moles of monomers or polymers M1 contained in C2. This ratio reflects the ability of the components of C2 to create a molecular network containing many junction points between molecules.

According to one embodiment, the composition C2 contains less than 5% by weight of molecules having no reactive function, preferably between 0.01% and 4%, more preferably between 0.01% and 3%.

This embodiment is advantageous in that it makes it possible to have a greater number of crosslinking points in the shell material of the capsules.

In fact, a “molecule having no reactive function” cannot be linked to any other molecule included in C2. A molecule with a single reactive function may only be linked to one other molecule included in C2, while a molecule with 2 reactive functions may be linked to 2 other molecules, and so on as the number of reactive functions increases.

According to one embodiment, the composition C2 comprises from 65% to 95% by weight of monomer or polymer, or a mixture of monomers or polymers, and from 5% to 30% by weight of crosslinking agent(s) relative to the total weight of the composition C2. According to one embodiment, the composition C2 may comprise from 0.1% to 5% by weight of photoinitiator or of a mixture of photoinitiators, relative to the total weight of the composition C2.

### Step b)

Step b) of the method according to the invention consists in preparing a second emulsion (E2).

The second emulsion consists of a dispersion of droplets of the first emulsion in a composition C3 immiscible with C2, and which is created by dropwise addition of the emulsion (E1) in C3 with stirring.

During step b), the emulsion (E1) is at a temperature between 15° C. and 60° C. During step b), composition C3 is at a temperature between 15° C. and 60° C.

Under the addition conditions of step b), the compositions C2 and C3 are not miscible with each other, which means that the quantity (by weight) of the composition C2 capable of being dissolved in composition C3, is less than or equal to 5%, preferably less than 1%, and more preferably less than 0.5%, relative to the total weight of composition C3, and that the quantity (by weight) of composition C3 capable of being dissolved in composition C2 is less than or equal to 5%, preferably less than 1%, and more preferably less than 0.5%, relative to the total weight of composition C2.

Thus, when the emulsion (E1) comes into contact with the composition C3 with stirring, the latter is dispersed in the form of drops, called double drops, the dispersion of these drops of emulsion (E1) in the continuous phase C3 being called emulsion (E2).

Typically, a double drop formed during step b) corresponds to a single drop of composition C1 as described above, surrounded by a shell of composition C2 which completely encapsulates said single drop.

The double drop formed during step b) may also comprise at least two single drops of composition C1, said single drops being surrounded by a shell of composition C2 which completely encapsulates said single drops.

Thus, said double drops comprise a core consisting of one or more single drops of composition C1, and a layer of composition C2 surrounding said core.

The resulting emulsion (E2) is generally a double polydisperse emulsion (C1-in-C2-in-C3 emulsion or C1/C2/C3 emulsion), which means that the double drops do not have a clear size distribution in the emulsion (E2).

The immiscibility between the compositions C2 and C3 makes it possible to avoid mixing between the layer of composition C2 and that of the composition C3, and thus ensures the stability of the emulsion (E2).

The immiscibility between the compositions C2 and C3 also makes it possible to prevent the water-soluble substance of composition C1 from migrating from the core of the drops to the composition C3.

To implement step b), it is possible to use any type of agitator typically used to form emulsions, such as, for example, a mechanical paddle stirrer, a static foam concentrate, an ultrasonic homogenizer, a membrane homogenizer, a high-pressure homogenizer, a colloid mill, a high-shear disperser, or a high-speed homogenizer.

### Composition C3

According to one embodiment, the viscosity of the composition C3 at 25° C. is greater than the viscosity of the emulsion (E1) at 25° C.

According to the invention, the viscosity of the composition C3 at 25° C. is between 500 mPa·s and 100,000 mPa·s.

Preferably, the viscosity of the composition C3 at 25° C. is between 3,000 mPa·s and 100,000 mPa·s, preferably between 5,000 mPa·s and 80,000 mPa·s, for example between 7,000 mPa·s and 70,000 mPa·s.

According to this embodiment, given the very high viscosity of the continuous phase formed by composition C3, the speed of destabilization of the double drops of the emulsion (E2) is significantly slower compared to the duration of the method of the invention, which then provides kinetic stabilization of the emulsions (E2) and then (E3), until the polymerization of the capsule shell is completed. The capsules, once polymerized, are thermodynamically stable.

Thus, the very high viscosity of the composition C3 ensures the stability of the emulsion (E2) obtained at the end of step b).

A low surface tension between C3 and the first emulsion as well as a high viscosity of the system make it advantageously possible to ensure the kinetic stability of the double emulsion (E2), preventing it from being out of phase during the duration of the manufacturing process.

Preferably, the interfacial tension between the compositions C2 and C3 is low. The low interfacial tension between the compositions C2 and C3 also makes it advantageously possible to ensure the stability of the emulsion (E2) obtained at the end of step b).

The volume fraction of the first emulsion in C3 may be varied from 0.05 to 0.5 in order, on the one hand, to improve the production yield and, on the other hand, to vary the average diameter of the capsules. At the end of this step, the size distribution of the second emulsion is relatively wide.

According to one embodiment, the ratio between the volume of emulsion (E1) and the volume of composition C3 varies between 1:10 and 10:1. Preferably, this ratio varies between 1:9 and 3:1, more preferably between 1:9 and 1:1.

According to one embodiment, composition C3 also comprises at least one branched polymer, preferably with a molecular weight greater than 5,000 g·mol⁻¹, and/or at least one polymer of molecular weight greater than 5,000 g·mol⁻¹, and/or solid particles such as silicates.

According to one embodiment, composition C3 comprises at least one branched polymer, preferably with a molecular weight greater than 5,000 g·mol⁻¹, more preferably between 10,000 g·mol⁻¹ and 500,000 g·mol⁻¹, for example between 50,000 g·mol⁻¹ and 300,000 g·mol⁻¹.

By “branched polymer” is meant a polymer having at least one branching point between its two end groups, a branching point being a point in a chain to which is attached a side chain also called a branched or pendant chain.

Among the branched polymers, mention maybe made, for example, of grafted or comb polymers, or even star polymers or dendrimers.

According to one embodiment, composition C3 comprises at least one polymer with a molecular weight greater than 5,000 g·mol⁻¹, preferably between 10,000 g·mol⁻¹ and 500,000 g·mol⁻¹, for example between 50,000 g·mol⁻¹ and 300,000 g·mol⁻¹.

For the polymer which may be used in composition C3, mention may be made of the following compounds, used alone or, alternatively, mixed together:
cellulose derivatives, such as cellulose ethers: methyl cellulose, ethyl cellulose, hydroxyethyl cellulose, methyl hydroxyethyl cellulose, ethyl hydroxyethyl cellulose, carboxymethyl cellulose, hydroxypropyl cellulose or methyl hydroxypropyl cellulose;
polyacrylates (also called carbomers), such as polyacrylic acid (PAA), polymethacrylic acid (PMAA), poly(hydroxyethyl methacrylate) (pHEMA), poly(N-2-hydroxypropyl methacrylate) (pHPMA);
polyacrylamides such as poly(N-isopropylacrylamide) (PNIPAM);
polyvinylpyrrolidone (PVP) and its derivatives;
polyvinyl alcohol (PVA) and its derivatives;
poly(ethylene glycol), poly(propylene glycol) and their derivatives, such as poly(ethylene glycol) acrylate/methacrylate, poly(ethylene glycol) diacrylate/dimethacrylate, polypropylene carbonate;
polysaccharides such as carrageenans, carob gums or tara gums, dextran, xanthan gums, chitosan, agarose, hyaluronic acids, gellan gum, guar gum, gum arabic, gum tragacanth, diutane gum, oat gum, karaya gum, ghatti gum, curdlan gum, pectin, konjac gum, starch;
protein derivatives such as gelatin, collagen, fibrin, polylysine, albumin, casein;
silicone derivatives such as polydimethylsiloxane (also called dimethicone), alkyl silicones, aryl silicones, alkyl aryl silicones, polyethylene glycol dimethicones, polypropylene glycol dimethicone;
waxes, such as diester waxes (alkanediol diesters, hydroxyl acid diesters), triester waxes (triacylglycerols, alkane-1,2-diol, w-hydroxy acid and fatty acid triesters, hydroxymalonic acid esters, fatty acid and alcohol, triesters of hydroxyl acids, fatty acid and fatty alcohol, triesters of fatty acid, hydroxyl acid and diol) and polyester waxes (polyesters of fatty acids). The fatty acid esters which may be used as waxes in the context of the invention are, for example, cetyl palmitate, cetyl octanoate, cetyl laurate, cetyl lactate, cetyl isononanoate, stearate cetyl, stearyl stearate, myristyl stearate, cetyl myristate, isocetyl stearate, glyceryl trimyristate, glyceryl tripalmitate, glyceryl monostearate or glyceryl and cetyl palmitate;
fatty acids which may be used as waxes such as cerotic acid, palmitic acid, stearic acid, dihydroxystearic acid, behenic acid, lignoceric acid, arachidic acid, myristic acid, lauric acid, tridecyclic acid, pentadecyclic acid, margaric acid, nonadecyclic acid, heneicosylic acid, tricosylic acid, pentacosylic acid, heptacosylic acid, montanic acid, or nonacosylic acid;
fatty acid salts, in particular, aluminum fatty acid salts such as aluminum stearate, hydroxyl aluminum bis(2-ethylhexanoate);
isomerized jojoba oil;
hydrogenated sunflower oil;
hydrogenated coconut oil;
hydrogenated lanolin oil;
castor oil and its derivatives, in particular modified hydrogenated castor oil, or the compounds obtained by esterification of castor oil with fatty alcohols;
polyurethanes and their derivatives;
styrenic polymers such as styrene butadiene;
polyolefins such as polyisobutene.

According to one embodiment, composition C3 may comprise solid particles such as clays, silicas and silicates.

As solid particles which may be used in composition C3, mention may be made of clays and silicates belonging, in particular, to the category of phyllosilicates (also called sheet silicas). By way of example of silicate which may be used in the context of the invention, mention may be made of Bentonite, Hectorite, Attapulgite, Sepiolite, Montmorillonite, Saponite, Sauconite, Nontronite, Kaolinite, Talc, Sepiolite, Chalk. Synthetic fumed silicas may also be used. The clays, silicates and silicas mentioned above may be advantageously modified by organic molecules such as polyethers, ethoxylated amides, quaternary ammonium salts, long chain diamines, long chain esters, polyethylene glycols, polypropylene glycols.

These particles may be used alone or mixed together.

According to one embodiment, composition C3 comprises at least one polymer with a molecular weight greater than 5,000 g·mol⁻¹ and solid particles. Any mixture of the compounds mentioned above may be used.

### Step c)

Step c) of the method according to the invention consists in refining the size of the drops of the second emulsion (E2).

This step may consist in applying a homogeneous controlled shear to the emulsion (E2), said applied shear speed being between 10 s⁻¹ and 100,000 s⁻¹.

According to one embodiment, the double polydisperse drops obtained in step b) are subjected to size refinement, which consists in subjecting them to a shear capable of fragmenting them into new double drops of homogeneous and controlled diameters. Preferably, this fragmentation step is carried out using a high-shear cell of the Couette type according to a method described in patent application EP 15 306 428.2.

According to one embodiment, in step c), the second emulsion (E2), obtained at the end of step b), which consists of double polydisperse drops dispersed in a continuous phase, is subjected to shear in a mixer, which applies a homogeneous controlled shear.

Thus, according to this embodiment, step c) consists in applying a homogeneous controlled shear to the emulsion (E2), said applied shear speed being between 1000 s⁻¹ and 100,000 s⁻¹.

According to this embodiment, in a mixer, the shear speed is said to be controlled and homogeneous, regardless of the duration, when it passes to an identical maximum value for all the parts of the emulsion at a given instant that may vary from one point of the emulsion to another. The exact configuration of the mixer is not essential according to the invention, as long as the entire emulsion has been subjected to the same maximum shear upon leaving this device. The mixers suitable for performing step c) are described, in particular, in document U.S. Pat. No. 5,938,581.

The second emulsion may undergo a homogeneous controlled shear when it circulates through a cell formed by:
two concentric rotary cylinders (also called a Couette type mixer);
two parallel rotating discs; or
two parallel oscillating plates.

According to this embodiment, the shear rate applied to the second emulsion is between 1,000 s⁻¹ and 100,000 s⁻¹, preferably between 1,000 s⁻¹ and 50,000 s⁻¹, and more preferably between 2,000 s⁻¹ and 20,000 s⁻¹.

According to this embodiment, during step c), the second emulsion is introduced into the mixer and is then subjected to shear which results in the formation of the third emulsion. The third emulsion (E3) is chemically identical to the second emulsion (E2) but consists of double monodisperse drops, while the emulsion (E2) consists of double polydisperse drops. The third emulsion (E3) typically consists of a dispersion of double drops comprising a core consisting of one or more drops of composition C1 and a layer of composition C2 encapsulating said core, said double drops being dispersed in composition C3.

The difference between the second emulsion and the third emulsion is the variation in size of the double drops: the drops of the second emulsion are polydispersed in size, while the drops of the third emulsion are monodispersed, thanks to the fragmentation mechanism described above.

Preferably, according to this embodiment, the second emulsion is introduced continuously into the mixer, which means that the amount of double emulsion (E2) introduced at the inlet of the mixer is the same as the amount of third emulsion (E3) at the outlet of the mixer.

Since the size of the drops of the emulsion (E3) essentially corresponds to the size of the drops of the solid microcapsules after polymerization, it is possible to adjust the size of the microcapsules and the thickness of the shell by adjusting the shear rate during step c), with a strong correlation between the decrease in drop size and the increase in shear rate. This allows the resulting dimensions of the microcapsules to be adjusted by varying the shear rate applied during step c).

According to a preferred embodiment, the mixer used during step c) is a Duvet type mixer, comprising two concentric cylinders, an external cylinder with internal radius Rₒ and an internal cylinder with external radius Rᵢ, wherein the external cylinder is fixed and the internal cylinder is in rotation with an angular speed ω.

A Duvet type mixer suitable for the method of the invention may be supplied by the company T.S.R. France.

According to one embodiment, the angular speed ω of the internal cylinder in rotation of the Couette type mixer is greater than or equal to 30 rad·s⁻¹.

For example, the angular speed ω of the rotating internal cylinder of the Duvet type mixer is around 70 rad·s⁻¹.

The dimensions of the fixed external cylinder of the Duvet type mixer may be chosen to modulate the space (d=Rₒ-Rᵢ) between the internal rotating cylinder and the fixed external cylinder.

According to one embodiment, the space (d=Rₒ-Rᵢ) between the two concentric cylinders of the Couette type mixer is between 50 μm and 1000 μm, preferably between 100 μm and 500 μm, for example between 200 μm and 400 μm.

For example, the distance d between the two concentric cylinders is 100 μm.

According to this embodiment, during step c), the second emulsion is introduced at the inlet of the mixer, typically via a pump, and is directed towards the space between the two concentric cylinders, the external cylinder being fixed and the internal cylinder being rotated at an angular speed w.

When the double emulsion is in the space between the two cylinders, the shear rate applied to said emulsion is given by the following equation:

$$γ = \frac{{R}_{i} ω}{( {R}_{o} - {R}_{i} )}$$

in which:
ω is the angular speed of the internal cylinder in rotation,
Rₒ is the internal radius of the fixed external cylinder, and
Rᵢ is the external radius of the internal cylinder in rotation.

According to another embodiment, when the viscosity of the composition C3 is greater than 2,000 mPa·s at 25° C., step c) consists in applying to the emulsion (E2) a shear rate of less than 1,000 s⁻¹.

According to this embodiment, the fragmentation step c) may be carried out using any type of mixer typically used to form emulsions with a shear rate of less than 1000 s⁻¹, in which case the viscosity of the composition C3 is greater than 2,000 mPa·s, namely under conditions such as those described in patent application FR 16 61787.

The geometric characteristics of the double drops formed at the end of this step will dictate those of future capsules.

According to this embodiment, in step c), the emulsion (E2), consisting of polydisperse drops dispersed in a continuous phase, is subjected to shear, for example in a mixer, at a low shear rate, namely less than 1000 s⁻¹.

According to this embodiment, the shear rate applied in step c) may be, for example, between 10 s⁻¹ and 1000 s⁻¹.

Preferably, the shear rate applied in step c) is strictly less than 1000 s−1.

According to this embodiment, the emulsion drops (E2) can only be effectively fragmented into fine, monodisperse emulsion drops (E3) if a high shear stress is applied to them.

The shear stress a applied to a drop of emulsion (E2) is defined as the tangential force per unit of drop surface resulting from the macroscopic shear applied to the emulsion during its stirring during step d).

The shear stress σ (expressed in Pa), the viscosity of the composition C3 η (expressed in Pa·$) and the shear rate γ (expressed in s⁻¹) applied to the emulsion (E2) during its stirring during step d) are connected by the following equation:

σ=ηγ

Thus, according to this embodiment, the high viscosity of the composition C3 makes it possible to apply a very high shear stress to the drops of emulsion (E2) in the mixer, even if the shear rate is low and the shear inhomogeneous.

To implement step c) according to this embodiment, any type of stirrer typically used to form emulsions my be used, such as, for example, a mechanical paddle stirrer, a static emulsifier, an ultrasonic homogenizer, a membrane homogenizer, a high-pressure homogenizer, a colloid mill, a high-shear disperser, or a high-speed homogenizer.

According to a preferred embodiment, a simple emulsifier such as a mechanical paddle stirrer or a static emulsifier may be used to carry out step c). In fact, this is possible because this embodiment requires neither controlled shear nor a shear rate greater than 1000 s⁻¹.

### Step d)

Step d) of the method of the invention consists of crosslinking and therefore the formation of the shell of the solid microcapsules according to the invention.

This step makes it possible to achieve the expected retention performance of the capsules and to ensure their thermodynamic stability by definitively preventing any destabilizing mechanism such as coalescence or curing.

According to one embodiment, when the composition C2 comprises a photoinitiator, step d) is a photopolymerization step consisting in exposing the emulsion

(E3) to a light source capable of initiating the photopolymerization of the composition C2, in particular to a UV light source preferably emitting in the wavelength range between 100 nm and 400 nm, in particular for a period of less than 15 minutes.

According to this embodiment, step d) consists in subjecting the emulsion (E3) to a photopolymerization, which will allow the photopolymerization of the composition C2. This step will make it possible to obtain microcapsules encapsulating the water-soluble substance as defined above.

According to one embodiment, step d) consists in exposing the emulsion (E3) to a light source capable of initiating the photopolymerization of the composition C2. Preferably, the light source is a UV light source.

According to one embodiment, the UV light source emits in the wavelength range between 100 nm and 400 nm.

According to one embodiment, the emulsion (E3) is exposed to a light source for a duration of less than 15 minutes, and preferably for 5 to 10 minutes.

During step d), the shell of the above-mentioned double drops, made up of the photocrosslinkable composition C2, is crosslinked and thus converted into a viscoelastic polymeric shell, encapsulating and protecting the water-soluble substance from its release in the absence of mechanical triggering.

According to another embodiment, when composition C2 does not include a photoinitiator, step d) is a polymerization step without exposure to a light source, the duration of this polymerization step d) preferably lying between 8 hours and 100 hours and/or this step d) is carried out at a temperature between 20° C. and 80° C.

According to this embodiment, the polymerization may be initiated, for example, by exposure to heat (thermal initiation), or by simple contacting of the monomers, polymers and crosslinking agents together, or with a catalyst. The polymerization time is then generally greater than several hours.

Preferably, step d) of polymerization of the composition C2 is carried out for a period of between 8 hours and 100 hours, at a temperature between 20° C. and 80° C.

The composition obtained at the end of step d), comprising solid microcapsules dispersed in composition C3, is ready for use and may be used without any additional step of post-treatment of the capsules being required.

The thickness of the shell of the microcapsules thus obtained is typically between 0.2 μm and 8 μm, preferably between 0.2 μm and 5 μm.

According to one embodiment, the solid microcapsules obtained at the end of step d) are devoid of surfactant.

The method of the invention has the advantage of not requiring a surfactant in any of the steps described. The method of the invention thus makes it possible to reduce the presence of additives which could modify the properties of the final product obtained after release of the active ingredient.

The present invention also relates to a series (or set) of solid microcapsules, capable of being obtained according to the method as defined above, in which each microcapsule comprises:
a core comprising a composition C1 as defined above, and
a solid shell completely encapsulating the core at its periphery, said solid shell comprising pores of size less than 1 nm,
wherein the average diameter of said microcapsules is between 1 μm and 30 μm, the thickness of the rigid shell is between 0.2 μm and 8 μm, preferably between 0.2 μm and 5 μm, and the standard deviation of the diameter distribution of the microcapsules is less than 50%, especially less than 25%, or less at 1 μm.

Preferably, the solid microcapsules obtained by the method of the invention are in the form of a core containing at least one active ingredient (composition C1) and a solid shell (obtained from composition C2) completely encapsulating said core at its periphery, said shell solid comprising pores with a size less than 1 nm.

As indicated above, the method of the invention makes it possible to obtain monodisperse particles. Also, the above-mentioned series of solid microcapsules is made up of a population of particles that are monodisperse in size. Thus, the standard deviation of the diameter distribution of the microcapsules is less than 50%, in particular less than 25%, or less than 1 μm.

The size distribution of the solid microcapsules may be measured by a light scattering technique using a Mastersizer 3000 (Malvern Instruments) equipped with a Hydro SV sample cell.

According to one embodiment, the above-mentioned solid microcapsules comprise a solid shell entirely composed of crosslinked polymer (obtained from composition C2), and comprising pores of size less than 1 nm.

As indicated above, the method of the invention makes it possible to obtain solid microcapsules. The present invention therefore also relates to solid microcapsules comprising a core and a solid shell completely encapsulating the core at its periphery, in which the core is the composition C1 as defined above, and in which said solid shell consists of crosslinked polymer and comprises pores of size less than 1 nm, the diameter of said microcapsule being between 1 μm and 30 μm, and the thickness of the rigid shell being between 0.2 μm and 8 μm.

In the context of the present invention, it is to be understood that the pore size less than 1 nm applies to any microcapsule before change in pH of the external environment or irradiation by UV radiation.

The present invention also relates to a composition comprising a series of solid microcapsules as defined above.

The terms “comprised between . . . and . . . ”, “comprised from . . . to . . . ” and “ranging from . . . to . . . ” must be understood as being inclusive, unless otherwise specified.

The examples which follow illustrate the present invention without limiting its scope.

### EXAMPLES

### Example 1

### Manufacture of pH-Sensitive Solid Capsules According to the Invention

A mechanical stirrer (Ika Eurostar 20) equipped with a deflocculation type stirring propeller is used to perform all the stirring steps.

Step a): Preparation of the First Emulsion (E1)

| | | % in the | % in |
|---|---|---|---|
| | Raw materials | composition | E1 |
| Composition | Active ingredient A: Modified | 18 | 30 |
| C1 | polyethylene glycol (Aculyn 44N | | |
| | Dow) | | |
| | Active ingredient B: Unicert Red | 1.5 | |
| | (CI45410, Sensient cosmetic | | |
| | technologies) | | |
| | Deionized water | 80.5 | |
| Composition | Oligomer M1 and crosslinking | 92 | 70 |
| C2 | agent (polyester diacrylate CN2035, | | |
| | Sartomer) | | |
| | Oligomer M2 (Eudragit EPO, | 5 | |
| | Evonik) | | |
| | Photoinitiator (Darocur 1173, | 3 | |
| | BASF) | | |

| | | |
|---|---|---|
| Total | 100 | 100 |

Composition C1 is placed under stirring at 1000 rpm until complete homogenization, and is then left to stand for one hour at room temperature. Composition C1 is then added dropwise to composition C2 with stirring at 2000 rpm with a 3:7 ratio. The first emulsion (E1) is thus obtained.

Step b): Preparation of the Second Emulsion (E2)

| | Raw materials | % |
|---|---|---|
| First emulsion E1 | — | 7 |
| Composition C3 | Sodium alginate (Sigma Aldrich) | 9.3 |
| | Deionized water | 83.7 |

| | |
|---|---|
| Total | 100 |

Composition C3 is stirred at 1000 rpm until complete homogenization and is then allowed to stand for one hour at room temperature. The first emulsion (E1) is then added dropwise to composition C3 with stirring at 2000 rpm. The second emulsion (E2) is thus obtained.

Step c): Size Refinement of the Second Emulsion

The second polydisperse emulsion (E2) obtained in the previous step is stirred at 2000 rpm for 3 minutes. A monodisperse emulsion (E3) is thus obtained.

Step d): Crosslinking of the Capsule Shell

The second monodisperse emulsion (E3), obtained in the previous step, is irradiated for 10 minutes using a UV light source (Dymax LightBox ECE 2000) having a maximum light intensity of 0.1 W/cm² at a wavelength of 365 nm.

The microcapsules thus obtained have a good size distribution, namely an average size of 5 μm and their size distribution has a standard deviation of 1 μm. When the capsules are subjected to a decrease in pH to a value less than 3, a swelling of the wall of the capsules is observed under the microscope, characteristic of the increase in porosity.

1. A method for the preparation of solid microcapsules,
said method comprising the following steps:
a) adding, with stirring, a composition C1, comprising at least one active ingredient, to a polymeric composition C2, the compositions C1 and C2 not being miscible with each other, the composition C2 comprising:
at least one crosslinkable monomer or polymer M1 with an average molecular weight of less than 5,000 g·mol⁻¹,
at least one monomer or polymer M2 having a chemical group sensitive to pH or to UV, wherein M2 is different from M1,
at least one crosslinking agent with an average molecular weight of less than 5,000 g·mol⁻¹
and, optionally, at least one photoinitiator with an average molecular weight of less than 5,000 g·mol⁻¹ or a crosslinking catalyst with an average molecular weight of less than 5,000 g·mol⁻¹,
the viscosity of composition C2 being between 500 mPa·s and 100,000 mPa·s at 25° C.,
wherein an emulsion (E1) is obtained comprising drops of composition C1 dispersed in composition C2;
b) adding, with stirring, the emulsion (E1) to a composition C3, wherein the compositions C2 and C3 are not miscible with each other,
the viscosity of composition C3 being between 500 mPa·s and 100,000 mPa·s at 25° C.,
wherein a double emulsion (E2) is obtained comprising drops dispersed in composition C3;
c) applying a shear to the emulsion (E2),
wherein a double emulsion (E3) is obtained comprising drops of controlled size dispersed in composition C3; and
d) polymerization of composition C2, wherein solid microcapsules are obtained dispersed in composition C3.

2. The method according to claim 1, wherein the volume fraction of C1 in C2 is between 0.1 and 0.5.

3. The method according to claim 1, wherein the composition C2 comprises from 5% to 30% by weight of crosslinking agent(s) relative to the total weight of said composition.

4. The method according to claim 1, in which the ratio of the number of moles of reactive functions of the monomers or polymers M1 contained in C2 relative to the number of moles of monomers or polymers M1 contained in C2, is greater than 1.5.

5. The method according to claim 1, wherein the composition C2 contains less than 5% by weight of molecules having no reactive function.

6. The method according to claim 1, in which step c) consists in applying a homogeneous controlled shear to the emulsion (E2), said applied shear rate being between 1,000 s⁻¹ and 100,000 s⁻¹.

7. The method according to claim 1, in which, when the viscosity of the composition C3 is greater than 2,000 mPa·s at 25° C., step c) consists in applying to the emulsion (E2) a shear rate of less than 1000 s⁻¹.

8. The method according to claim 1, in which, when the composition C2 comprises a photoinitiator, step d) is a photopolymerization step consisting in exposing the emulsion (E3) to a source of light capable of initiating the photopolymerization of composition C2.

9. The method according to claim 1, in which, when the composition C2 does not comprise a photoinitiator, step e) is a polymerization step, without exposure to a light source.

10. The method according to claim 9, in which the composition C3 further comprises at least one branched polymer, and/or at least one polymer with a molecular weight greater than 5000 g·mol⁻¹, and/or solid particles such as silicates.

11. The method according to claim 1, in which the monomer or polymer M2 is chosen from the group consisting of:
monomers or polymers comprising at least one function chosen from among the group consisting of the functions of pyridine, pyrrolydine, imidazole, piperazine, morpholino, primary amine, secondary amine, tertiary amine, carboxyl, sulfonic and phosphate groups;
monomers or polymers comprising at least one chemical bond chosen from the orthoester, lactone or ester functions; and
monomers or polymers comprising at least one function chosen from among the group consisting of the functions of azobenzene, stilbene, spiropyran, 2-diazo-1,2-naphthoquinone, o-nitrobenzylester, triphenylmethane, coumarin, thiol and 6-nitro-veratroyloxycarbonyl functions.

12. A series of solid microcapsules, in which each microcapsule comprises:
a core comprising a composition C1 as defined according to claim 1, and
a solid shell completely encapsulating the core at its periphery, said solid shell comprising pores with a size less than 1 nm,
wherein the average diameter of said microcapsules is between 1 μm and 30 μm, the thickness of the solid shell is between 0.2 μm and 8 μm, and the standard deviation of the diameter distribution of the microcapsules is less than 50%, or less than 1 μm.

13. A composition comprising a series of solid microcapsules according to claim 12.
